(19) United States
(12) Patent Application Publication
(10) Pub. No.: US 2003/0004807 A1
(43) Pub. Date: Jan. 2, 2003

(54) Apparatus and method for providing information with advertisement

(76) Inventor: Keisuke Iwasaki, Nara (JP)

Correspondence Address: EDWARDS & ANGELL, LLP., P.O. BOX 9169, BOSTON, MA, 02209, US

(21) Appl. No.: 10/181,575

(22) PCT Filed: Jun. 12, 2001
(86) PCT No.: PCT/JP01/04939

(30) Foreign Application Priority Data
Jun. 28, 2000 (JP) 2000-193744

(51) Int. Cl. G06F 17/60

(52) U.S. Cl. 705/14

(57) ABSTRACT

In advertisement-attached information providing services, it has not been possible to properly control the fee to be paid by a user and the advertisement fee to be paid by an advertiser.

The invention provides an advertisement-attached information providing apparatus for providing information attached with an advertisement. The advertisement carries an advertisement unit price or an advertisement fee that is incurred every time the advertisement is attached to the information. The information is provided for a fee which is the price of the information minus the advertisement unit price.

### TECHNICAL FIELD

The present invention relates to an advertisement-attached information providing apparatus and method for providing information, including images, text and voice, attached with an advertisement.

### BACKGROUND ART

Recent years have witnessed the emergence of paid information providing services in which information in the form of, e.g., images, voice and text, is transmitted via the Internet or information kiosks (information vending machines) to devices such as, e.g., mobile phones, mobile terminals and personal computers for an information or services fee.

It is known from Japanese Patent Application Laid-Open (Kokai) 9-114755 that a discount in the fee is provided by outputting an advertisement when the information is utilized, so that the fee for the use of the information providing services as mentioned above can be reduced.

In the advertisement-attached information providing services according to the prior art, however, though the system or mechanism concerning the discount of the fee charged to the user is indicated, the system concerning the setting of the fee charged to the advertiser who provides the advertisement is not. Thus, for example, when an advertisement fee is determined in accordance with the period in which the advertisement-attached information is provided, the advertiser had to pay a set advertisement fee even when the quantity of the advertisement-attached information that was provided was less than what the advertiser had hoped.

Further, when the server providing advertisement-attached information stores the quantity of the advertisement-attached information that has been provided, and the advertiser is charged an advertisement fee proportional to that quantity at certain intervals (e.g., every month), the advertiser may have to pay an advertisement fee which far exceeds what he had expected if the quantity of the information provided far exceeds expectations.

In addition, since there is no indication of the association between the advertisement provided by the advertiser and the user who views the advertisement, it is difficult for the advertiser to target his advertisement to certain users. In view of these problems of the prior art, it is a major objective of the present invention to provide an advertisement-attached information providing apparatus which enables the advertiser to provide certain users with a quantity of advertising commensurate with the advertisement fee the advertiser paid, and which enables the user to obtain a discount in the fee.

### DISCLOSURE OF THE INVENTION

In order to overcome the problems of the prior art, the present invention provides an advertisement-attached information providing apparatus for providing information attached with an advertisement, wherein the advertisement attached to the information is determined based on at least two pieces of information selected from the group consisting of advertisement desired information included in the information, user taste information included in the advertisement, and user information about a user who purchases the information.

According to the present invention, at least two pieces of information selected from the group consisting of each item of the advertisement desired information about the type of advertisement a provider of information wishes to be attached to the information, each item of the user taste information indicating the characteristics of a user by whom the one providing an advertisement wants the advertisement to be viewed, and the user information about the user who purchases the information, are compared, and then an advertisement with the most corresponding items is selected. Accordingly, an appropriate advertisement in accordance with the content of the information can be attached.

Further, the present invention provides an advertisement-attached information providing apparatus, wherein the advertisement carries an advertisement unit price which, corresponding to an advertisement fee, is incurred every time the advertisement is attached to the information, and the information is provided for a fee which is the price of the information minus the advertisement unit price.

According to the present invention, since the advertisement data to be attached to the information comprises advertisement unit price data, the advertiser can set an advertisement fee commensurate with the quantity of advertisement attached to the information.

Furthermore, the present invention provides an advertisement-attached information providing apparatus, wherein the advertisement further comprises data indicating an upper-limit price for the advertisement fee, and the attachment of the advertisement is halted when the total of the advertisement unit price, which is incurred every time the advertisement is attached to the information, exceeds the upper-limit price.

According to the present invention, the advertisement data to be attached to the information comprises upper-limit price data for the advertisement fee to be paid by the advertiser, and the attachment of the advertisement is halted when the total of the advertisement unit fee, which is incurred every time the advertisement is attached to the information, exceeds the upper-limit price. Accordingly, the advertiser is spared from being charged with a fee exceeding a preset advertisement fee.

Furthermore, the present invention provides an advertisement-attached information providing apparatus, wherein the advertisement further comprises data indicating an advertisement period, and the attachment of the advertisement is halted when the time or date of attaching the advertisement to the information has passed the advertisement period.

According to the present invention, since the advertisement data to be attached to the information comprises data indicating an advertisement distribution period, an advertisement with a certain effective period can be effectively distributed.

The present invention further provides an advertisement-attached information providing method for providing information attached with an advertisement, the method comprising the steps of: extracting advertisement desired information included in the information; extracting user taste information included in the advertisement; and determining an advertisement to be attached to the information based on the extracted advertisement desired information and the extracted user taste information.

According to the present invention, each item of the advertisement desired information indicating the type of advertisement which the one providing information wishes to be attached to the information, is compared with each item of the user taste information indicating the characteristics of the user by whom the one providing an advertisement wants the advertisement to be viewed, so that an advertisement with the most corresponding items can be selected. Thus, an appropriate advertisement in accordance with the content of the information can be attached.

The present invention further provides an advertisement-attached information providing method, wherein in the case where user information about a user who purchases the information is provided, the content of each item of the advertisement desired information corresponding to each item of the provided user information is temporarily changed to the content of the user information.

According to the present invention, when the user information such as, e.g., age and place of residence is provided, the user information is given priority over the advertisement desired information indicating the type of advertisement which the one providing the information wishes to be attached to the information. Accordingly; the advertiser can provide an advertisement matching the characteristics of the user.

The present invention also provides a program for providing information attached with an advertisement, comprising the steps of: extracting advertisement desired information included in the information; extracting user taste information included in the advertisement; and determining an advertisement to be attached to the information based on the extracted advertisement desired information and the extracted user taste information.

The present invention further provides a computer-readable recording medium recorded with a program for providing information attached with an advertisement, the program being designed to execute the steps of extracting advertisement desired information included in the information; extracting user taste information included in the advertisement; determining an advertisement to be attached to the information based on the extracted advertisement desired information and the extracted user taste information.

According to these inventions, each item of the advertisement desired information indicating the type of advertisement which the one providing information wishes to be attached to the information is compared with each item of the user taste information indicating the characteristics of the user by whom the advertisement provider wishes the advertisement to be viewed, so that the advertisement with the most corresponding items can be selected. Thus, an appropriate advertisement in accordance with the content of the information can be attached.

The present invention further provides an advertisement-attached information providing method for providing information attached with an advertisement, comprising the steps of: extracting an advertisement to be attached to the information; extracting an advertisement unit price corresponding to the extracted advertisement; calculating a fee for the advertisement-attached information by subtracting the advertisement unit price from the price of the information; and the advertisement-attached information is provided.

According to these inventions, since the advertisement data to be attached to the information comprises the advertisement unit price data, the advertiser can set an advertisement fee commensurate with the quantity of the advertisement attached to the information.

The present invention further provides a program for providing information attached with an advertisement, the program being designed to execute the steps of: extracting an advertisement to be attached to information; extracting an advertisement unit price corresponding to the extracted advertisement; calculating a fee for the advertisement-attached information by subtracting the advertisement unit price from the price of the information; and providing the advertisement-attached information.

The present invention also provides a computer-readable recording medium recorded with a program for providing information attached with an advertisement, the program being designed to execute the steps of: extracting an advertisement to be attached to the information; extracting an advertisement unit price corresponding to the extracted advertisement; calculating a fee for the advertisement-attached information by subtracting the advertisement unit price from the price of the information; and providing the advertisement-attached information.

According to these inventions, since the advertisement data attached to the information comprises the advertisement unit price data, the advertiser can set an advertisement fee commensurate with the quantity of advertisements attached to the information.

This specification includes part or all of the contents as disclosed in the specification and/or drawings of Japanese Patent Application No. 2000-193744, which is a priority document of the present application.

### BRIEF DESCRIPTION OF THE DRAWINGS

FIG. 1 shows a diagram of the advertisement-attached information providing apparatus according to an embodiment of the present invention.

FIG. 2 shows a diagram of the system of the advertisement-attached information providing apparatus according to the embodiment of the present invention.

FIG. 3 illustrates the structure of information data used in the advertisement-attached information providing apparatus according to the embodiment of the present invention.

FIG. 4 illustrates the structure of advertisement data used in the advertisement-attached information providing apparatus according to the embodiment of the present invention.

FIG. 5 shows the structure of user information data used in the advertisement-attached information providing apparatus according to the embodiment of the present invention.

FIG. 6 shows a flowchart of the process starting from the selection of an advertisement to be attached to information selected by a user to the provision of the information in the embodiment of the present invention.

FIG. 7 shows a flowchart of the process including the selection of an advertisement to be attached to information selected by the user and the calculation of a fee according to the embodiment of the present invention.

FIG. 8 shows the hardware structure of the advertisement-attached information providing apparatus according to the embodiment of the present invention.

### BEST MODE OF CARRYING OUT THE INVENTION

Hereafter, a embodiment of the present invention will be described by referring to the attached drawings.

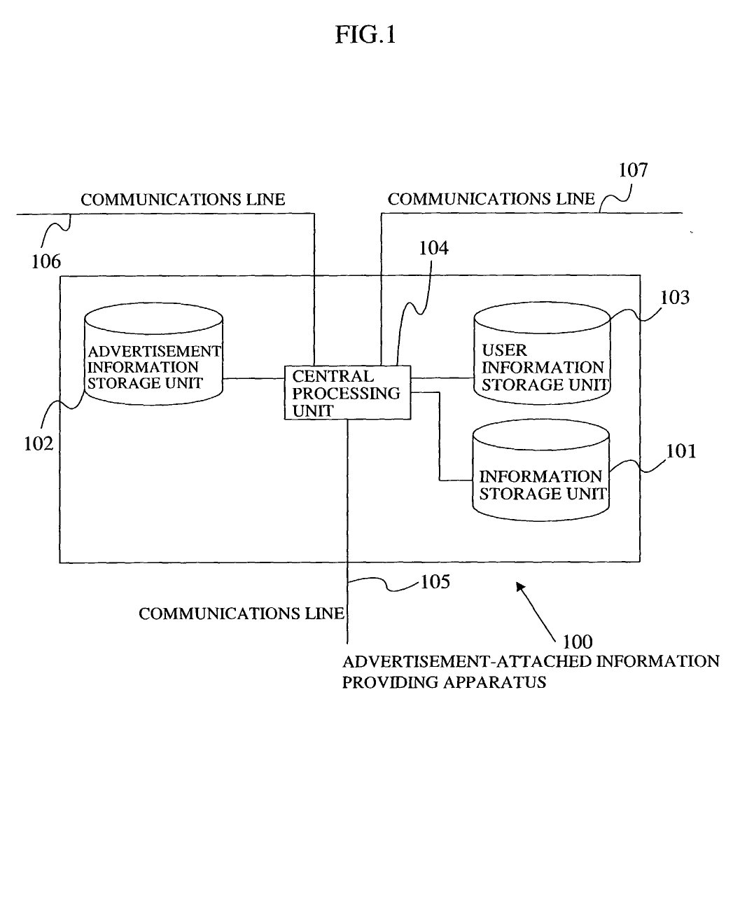

FIG. 1 shows a diagram of an advertisement-attached information providing apparatus in the present embodiment of the invention. In FIG. 1, numeral 100 designates an advertisement-attached information providing apparatus; 101 an information storage unit for storing information to be provided; 102 an advertisement information storage unit for storing advertisements to be attached to provided information; 103 a user information storage unit for storing personal information of users; 104 a central processing unit for controlling the processing performed in the advertisement-attached information providing apparatus 100; 105, 106 and 107 communication lines. The communication lines 105, 106 and 107 may include the Internet and dedicated lines and may either be cables or wireless.

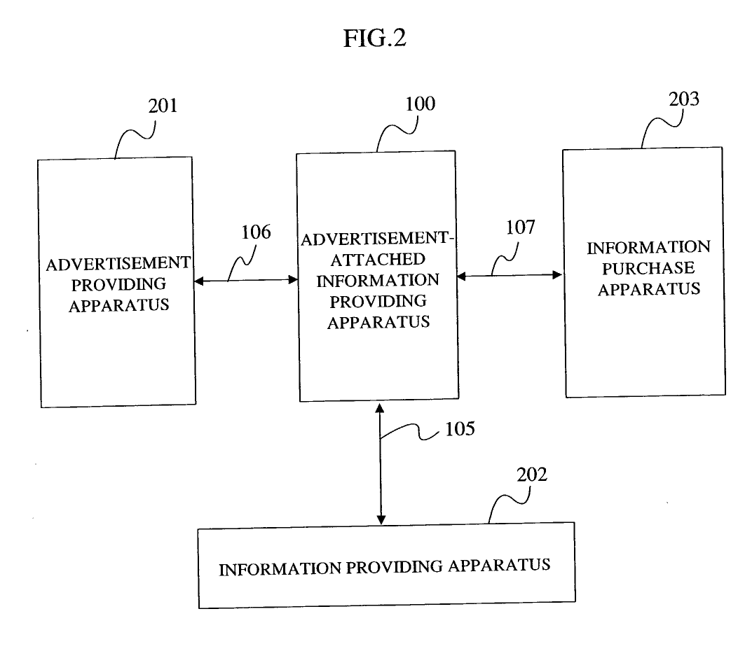

FIG. 2 shows a diagram of a system for providing advertisement-attached information to a user by using the advertisement-attached information providing apparatus 100 in the present embodiment. Similar numerals are used for referencing elements similar to those of FIG. 1. In FIG. 2, numeral 201 designates an advertisement providing apparatus for providing an advertisement to the advertisement-attached information providing apparatus 100; 202 an information providing apparatus for providing information to the advertisement-attached information providing apparatus 100; and 203 an information purchase apparatus for purchasing information from the advertisement-attached information providing apparatus 100.

Hereafter, the embodiment of the invention where the advertisement-attached information providing apparatus 100 is used for providing advertisement-attached information to a user will be described by referring to FIGS. 1 and 2. In the present embodiment, the one who provides information from the information providing apparatus 202 to the advertisement-attached information providing apparatus 100 is called an information provider, the one who provides an advertisement from the advertisement providing apparatus 201 to the advertisement-attached information providing apparatus 100 is called an advertiser, and the one who purchases information with an advertisement from the advertisement-attached information providing apparatus 100 is called a user.

First, the process of the information provider providing information to the advertisement-attached information providing apparatus 100 will be described.

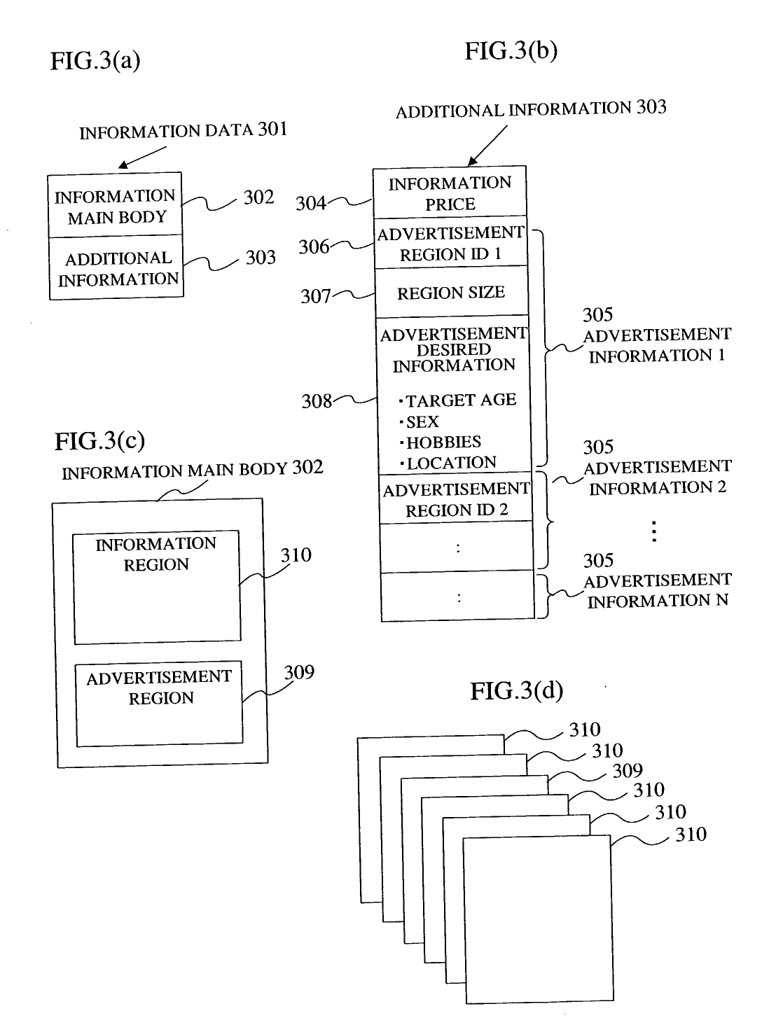

The information provider provides information from the information providing apparatus 202 via the communication line 105 to the advertisement-attached information providing apparatus 100. FIG. 3(a) shows the data structure of the information. As shown in FIG. 3(a), information data 301 comprises information main body 302 indicating the content itself, such as an image and voice, and additional information 303 indicating information additional to the information main body. The information main body 302 is the information which is eventually provided, after being attached with an advertisement, to the one who purchases the information, i.e., the user. The information main body 302 has a predetermined region for the attachment of an advertisement.

FIG. 3(b) shows the data structure of the additional information 303. As shown, the additional information 303 comprises an information price 304 indicating the price of the information main body 302, and advertisement information 305. The advertisement information 305 is the information which is utilized when an advertisement is attached to the information main body 302 in the advertisement-attached information providing apparatus 100. The advertisement information 305 comprises an advertisement region ID 306 for identifying a region where an advertisement is attached, a region size 307 indicating the data size of the advertisement region, and an advertisement desired information 308 for identifying the type of advertisement attached. The advertisement desired information 308 comprises data such as target age, sex, hobbies, locations, etc., and sets a content corresponding to the advertisement desired by the information provider to be attached to the information main body 302. Since, as shown, it is possible to set a plurality of pieces of information in the advertisement information 305, such as, e.g., advertisement information 1, advertisement information 2, and so on, it is possible to attach a plurality of kinds of advertisements to a single piece of information. In this case, the correspondence as to in which position of the information main body 302 each advertisement is attached is indicated by the advertisement region ID 306.

FIG. 3(c) concerns the case where the information main body 302 is an electronic dictionary. As shown, an information region 310 for displaying the content of the electronic dictionary and an advertisement region 309 are designated such that they are displayed on the same page. As shown, the advertisement attached to the advertisement region 309 and the additional information 303 are associated with one another by the advertisement region ID 306. Alternatively, the page where the advertisement is displayed and the page where the contents of the electronic dictionary are displayed may be separated, as shown in FIG. 3(d).

The advertisement-attached information providing apparatus 100 stores the provided information data 301 in the information storage unit 101 under the control of the central processing unit 105. As a plurality of information providers provide information in a repeated manner, a plurality of pieces of information data 301 are stored in the information storage unit 101.

Next, the process of the advertiser providing an advertisement to the advertisement-attached information providing apparatus 100 will be described.

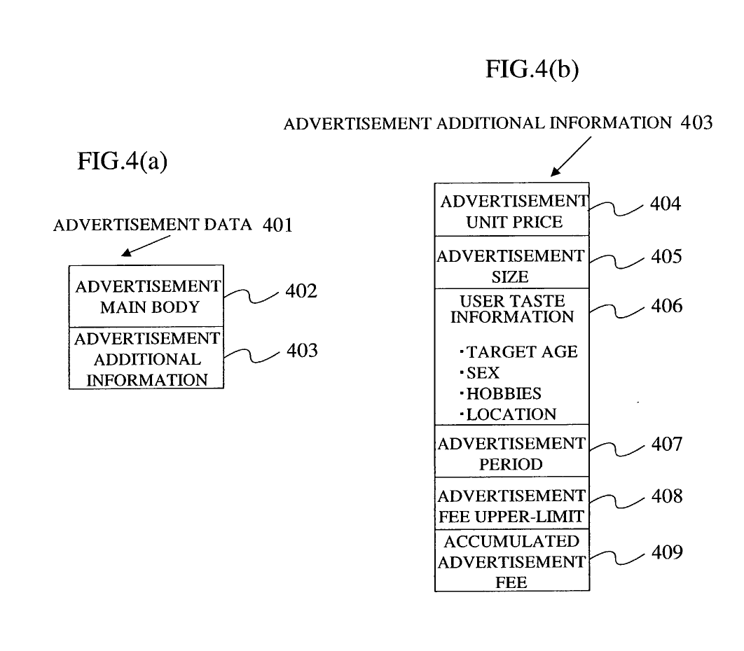

The advertiser provides an advertisement from the advertisement providing apparatus 201 via the communication line 106 to the advertisement-attached information providing apparatus 100. FIG. 4(a) shows the data structure of the advertisement. As shown in FIG. 4(a), the advertisement data 401 comprises an advertisement main body 402 indicating the advertisement data per se, such as an image and voice, and an advertisement additional information 403 indicating information additional to the advertisement main body. The advertisement main body 402 attached to the information main body 302 is selected either based on a result of comparison between the advertisement desired information 308 and a user taste information 406 which will be described later, or on a result of comparison between the user taste information 406 and user information 501 which both will be described later; the process will be described in detail later.

FIG. 4(b) shows the data structure of the advertisement additional information 403. As shown in FIG. 4(b), the advertisement additional information 403 comprises an advertisement unit price 404, an advertisement size 405 indicating the data size of the advertisement, user taste information 406 indicating the taste of the user targeted by the advertisement, an advertisement period 407 indicating the effective period of the advertisement, an advertisement fee upper-limit 408 indicating the upper limit of the advertisement fee to be paid by the advertiser, and an accumulated advertisement fee 409 indicating the total accumulated amount of the advertisement unit price 404 is as it is incurred each time the advertisement main body 402 is selected and attached to the information main body 302. The advertisement unit price 404 incurred every time the advertisement main body 402 corresponding to the advertisement additional information 403 is selected according to a selection method which will be described later and added to the information main body 302. The advertisement unit price 404 corresponds to the advertisement fee to be paid by the advertiser. The advertisement unit price 404 also corresponds to the amount of discount in the fee to be paid by the user as he purchases the information. When the amount of the accumulated advertisement fee 409 exceeds the advertisement fee upper-limit 408, the advertisement is not attached thereafter. The advertisement period 407 indicates the period in which the information main body 302 may be sold as attached with the advertisement main body 402. After this period, the attachment of the advertisement main body 402 is halted. The user taste information 406 includes target age, sex, hobbies, location and other data, and sets a content corresponding to the user to which the advertiser wishes to provide the advertisement.

The advertisement-attached information providing apparatus 100 stores the provided advertisement data 401 in the advertisement information storage unit 102 under the control of the central processing unit 105. As a plurality of advertisers provide the advertisement data 401 in a repeated manner, a plurality of pieces of advertisement data 401 are stored in the advertisement information storage unit 102.

Hereafter, the process of the user purchasing advertisement-attached information from the advertisement-attached information providing apparatus 100 will be described.

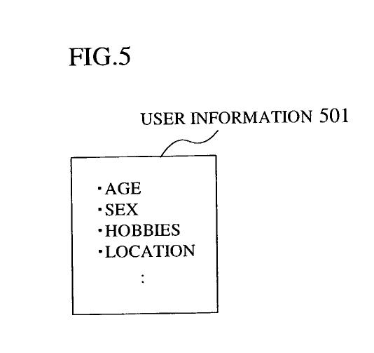

Initially, the user views the content of the information stored in the advertisement-attached information providing apparatus 100 by using the information purchasing apparatus 203, and selects the information he wishes to purchase. Next, the user transmits his personal information and stores it in the user information storage unit 103. FIG. 5 shows an example of the data structure of the user's personal information. As shown in FIG. 5, the user information 501 comprises data such as age, sex, hobbies, and area of residence.

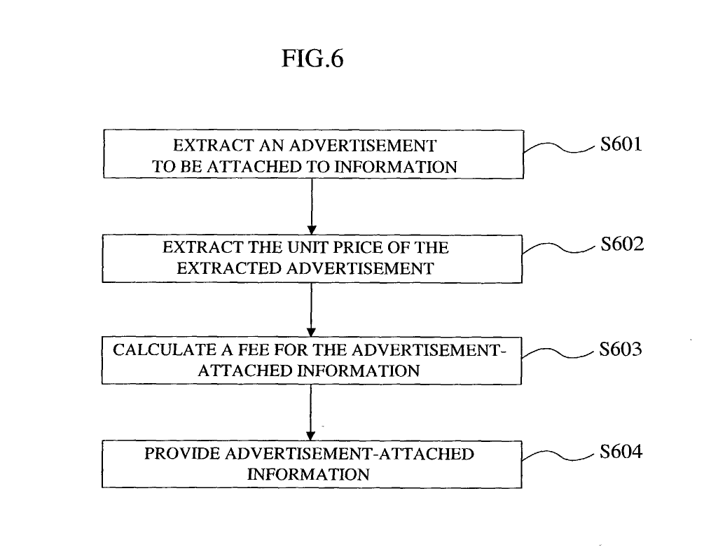

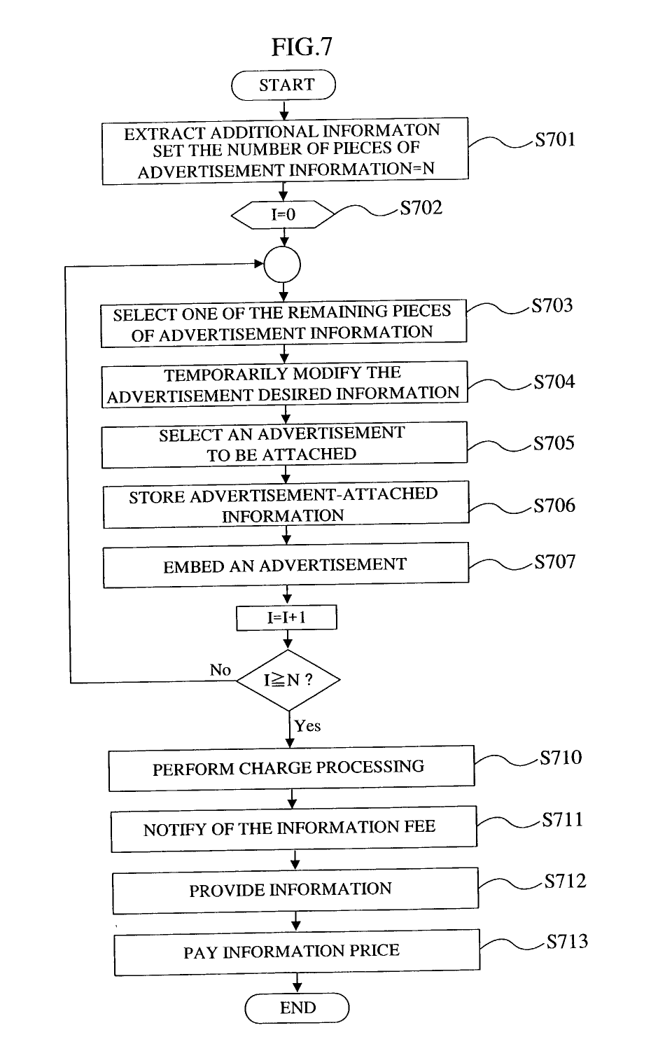

The advertisement-attached information providing apparatus 100 then selects the advertisement to be attached to the selected information and calculates the fee after a discount in the case of attaching an advertisement. Hereafter, this process will be described by referring to FIGS. 6 and 7.

FIG. 6 shows a flowchart of the process starting from the selection of the advertisement to be attached to the user-selected information to the provision of the information. As shown in FIG. 6, first the most appropriate advertisement corresponding to the selected information is extracted based on the advertisement desired information 308, user taste information 406, and user information 501 (S601). The extraction method will be described in detail later by referring to FIG. 7. Next, the advertisement unit price 404 of the extracted advertisement is extracted from the advertisement additional information 403 (S602). Thereafter, the fee for the advertisement to be attached to the information (advertisement unit price 404) is subtracted from the price of the selected information (information price 304) to calculate a fee which is the fee for the advertisement-attached information (S603). Then, the advertisement-attached information is provided to the user via the communication line 107 (S604).

FIG. 7 shows a flowchart of the detailed process of the selection of the advertisement to be attached to the information selected by the user and the calculation of the fee in the advertisement-attached information providing apparatus 100.

Initially, the additional information 303 corresponding to the selected information is extracted from the information storage unit 101, the number of pieces of the advertisement information 305 set in the extracted additional information 303 is substituted in N (S701), and the value of a variable I is set at 0 (S702). The variable I is used in a counter when an N number of pieces of advertisement information are attached to the information main body 302.

Thereafter, one of the remaining pieces of advertisement information 305 from the N number of items of advertisement information 305 that have not been selected yet is selected (S703).

Next, it is determined whether or not there is an input in any of the items of the user information 501. If there is an input item, the content of a corresponding item in the advertisement desired information 308 is temporarily changed to the content of the user information 501 (to be hereafter referred to as temporary advertisement desired information) (S704). Namely, when there is personal information provided by the user, that information is adopted in preference to the advertisement desired information 308. Thus, when deciding on the content of the advertisement to be attached to the information, it becomes possible to take into consideration not only the desired information from the advertiser and the information provider, but also the user's personal information. In the case where the user provided not all but only some of the items in the user information 501 for privacy protection reasons, the temporary change may be made by using only the available items. If the user did not provide any user information 501 for privacy protection reasons, the temporary advertisement desired information is not created, and the decision is made based on the result of comparison between the advertisement desired information 308 and the user taste information 406. The decision method is such, for example, that each item of the advertisement desired information 308 and each item of the user taste information 406 are compared with each other, and an advertisement with the most corresponding items is selected.

Next, the advertisement size 405 of each advertisement additional information 403 stored in the advertisement information storage unit 102 is compared with the region size 307 of the selected information data 301. Based on the result of the comparison, the advertisement data 401 is selected (S705). The method of comparison is such, for example, that an advertisement size smaller than the region size is selected. Further, each item of the user taste information 406 of each selected advertisement additional information 403 is compared with each item of the above-mentioned temporary advertisement desired information. Based on the result of this comparison, a further optimal advertisement data 401 is selected from the advertisement data 401 that was selected in S705. The method of comparison is such, for example, that each item of the user taste information 406 is compared with each item of the temporary advertisement desired information, and the advertisement data with the most corresponding items is selected. It should be noted, however, that the advertisement data whose accumulated advertisement fee 406 exceeds the advertisement fee upper-limit 408 is excluded from the selection so as to prevent the advertisement from being attached any more. Similarly, the advertisement data whose time or date of selection exceeds the advertisement period 407 is also excluded from the selection so as to prevent the advertisement from being attached any more. The advertisement period is useful when an advertisement is to be only effective during a limited period of time and its period of distribution should be limited. Such an advertisement may read, for example, “Product A is discounted by 50% at a shop XXX only during May 1-31, 2000.” When a plurality of pieces of advertisement data 401 are selected, one of the selected pieces of advertisement additional information 403 that has the highest advertisement unit price 404 may be selected.

Then, the selected advertisement additional information 403 is stored temporarily as advertisement additional information Ki (S706), and the advertisement main body 402 corresponding to the advertisement additional information 403 is extracted. The extracted advertisement main body 402 is embedded in an advertisement region 309 within the information main body 302 which corresponds to the advertisement region ID 306 existing in the advertisement information 305 selected in S703.

Then, the variable I is incremented by one (S708), and the variable I is compared with the number N of advertisement information pieces (S709). If I is smaller than N, the process returns to S703, and if I is larger than N, the process goes on to S710.

In S710, a charge processing is performed. First, the advertisement unit fee 404 corresponding to each advertisement additional information 403 selected in S705 is added to a corresponding accumulated advertisement fee 409. Specifically, the advertisement unit price 404 present in each advertisement additional information Ki stored in S706 is taken as Yi, and Yi is added to the accumulated advertisement fee 409 in Ki. Next, the advertisement unit price 404 of each advertisement information selected in S705 is summed up to calculate a total advertisement fee Ya, such that the total advertisement fee Ya=ΣYi(i=0 to N). Next, if the total advertisement fee Ya exceeds the information price 304 described in the additional information 303 corresponding to the selected information, that is if X<Ya where X is the information price, the amount by which the total advertisement fee exceeds the information fee is returned to the advertisement fee. Namely, with respect to each advertisement i, an amount calculated by (Ya−X)Yi/Ya is subtracted from the accumulated advertisement fee 409 in each advertisement-attached information Ki.

In S711, the information fee to be ultimately paid by the user is calculated and charged to the user. Specifically, if X<Ya in S710, the information fee is free, and in other cases, the user is notified of X−Ya as the information fee via the communication line 107 and information purchase apparatus 203, and the fee is collected.

In S712, after acknowledging the payment of the information fee by the user as notified in S711, the information main body 302 embedded with the advertisement is provided to the user.

In S713, a counter-value for the information, i.e., the information price X, is paid via the communication line 105 and information providing apparatus 202 to the corresponding information provider.

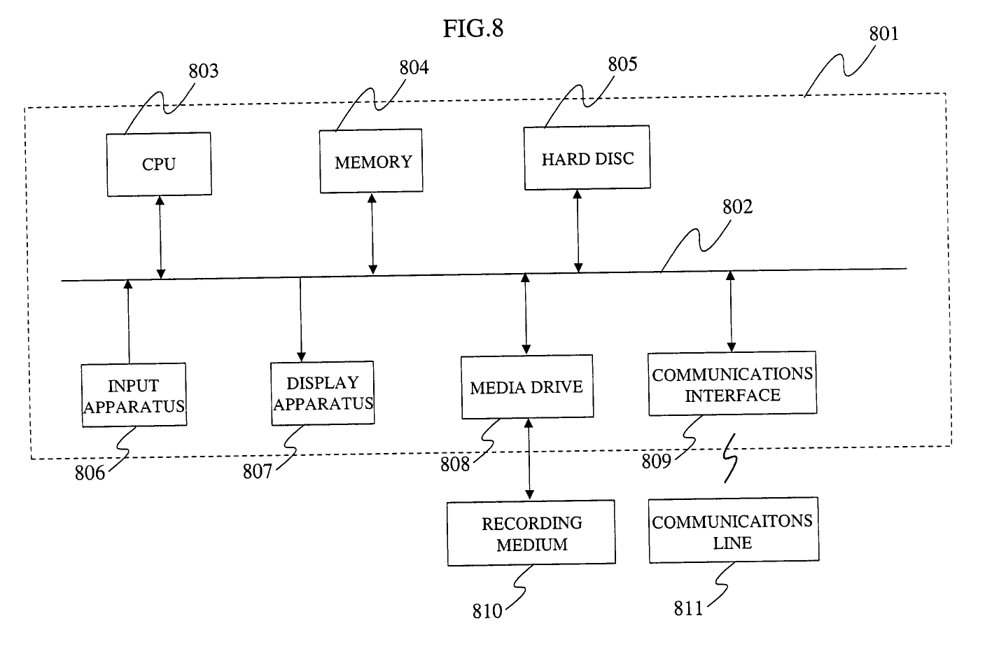

Hardware in the present embodiment including the advertisement-attached information providing apparatus 100, the advertisement providing apparatus 201, the information providing apparatus 202, and the information purchase apparatus 203 is configured from a general-purpose computer, as shown in FIG. 8.

Referring to FIG. 8, numeral 801 designates a computer main unit comprising a CPU (central processing unit) 803, a memory 804, a hard disc 805, an input apparatus 806, a display apparatus 807, a media drive 808, and a communications interface 809 which are all connected via a bus line 802.

CPU 803, which is comprised of a microprocessor, for example, controls the computer as a whole by executing a program in the memory 804 or on the hard disc 805. The memory 804 is comprised of a RAM (random access memory) and a ROM (read-only memory) and used for the storage of the program or various data. The hard disc 805 is used for the storage of the information to be provided, advertisements to be attached to the information, personal information of the users, etc., in the case of the advertisement-attached information providing apparatus 100.

The input apparatus 806, which is an interface for operating the present apparatus, is comprised, e.g., of a keyboard, a mouse, a touch panel, button or the like. The display apparatus 807 is a device for displaying various information for, e.g., acknowledging purposes. The display apparatus may be comprised of a CRT (cathode-ray tube) or an LCD (liquid crystal display), for example.

The media drive 808 is used for reading and writing information on a recording medium 810 and comprised of an FD (floppy disc), MO (magneto-optical disc), MD (mini disc), or the like.

The communications interface 809 is used for interfacing with a communications line 811 such as the Internet, for example.

While in the present embodiment, the processes illustrated in FIGS. 6 and 7 have been described to be performed by the advertisement-attached information providing apparatus 100, the processes may be partly or entirely recorded on a computer-readable recording medium such as a floppy disc or CD-ROM, or loaded onto the advertisement-attached information providing apparatus 100 via the communications line, before they are executed.

Further, in the present embodiment, it is possible to simplify the process of transmitting the user information every time the user purchases the information. For example, the user information 501 is transmitted when the user utilizes the service for the first time, and the transmitted user information 501 is registered in the user information storage unit 103 of the advertisement-attached information providing apparatus 100. As the user information is registered, the advertisement-attached information providing apparatus 100 issues a user ID number which is then provided to the user. When the user comes to input the user information for the second time and later, he only needs to input his ID number to the information purchasing apparatus 203, and the advertisement-attached information providing apparatus 100 can associate the user ID number with user information that is already registered.

In the present embodiment, the maintenance of the advertisement information storage unit 102 in the advertisement-attached information providing apparatus 100 may be performed as follows. Namely, the advertisement-attached information providing apparatus 100 extracts, at predetermined intervals, those pieces of advertisement information in the advertisement information storage unit 102 whose advertisement periods have already been passed by the current time or date or in which the difference between the advertisement fee upper-limit 408 and the accumulated advertisement fee 409 is smaller than the advertisement unit fee 404. Then, the individual advertisers who provided those pieces of extracted advertisement information are notified, via the communications line 106 and advertisement providing apparatus 201, of the fact that further attachment of advertisements is not possible, while paying back the amount of money equivalent to the upper-limit advertisement fee minus the accumulated advertisement fee.

In the present embodiment, when the advertiser wishes to know the current accumulated advertisement fee 409, he can request, via the communications line 106 and the advertisement providing apparatus 201, the advertisement-attached information providing apparatus 100 to notify him of that information.

While the present embodiment is arranged such that the user always transmits the user information, and the type of the advertisement is determined based on that information, it is possible to determine the advertisement based on the advertisement desired information 308 and user taste information 406 without the transmission of the user information.

Moreover, in the present embodiment, it is possible to determine the advertisement attached to the information based on at least two pieces of information selected from the group consisting of the advertisement desired information indicating the type of advertisement which the information provider wishes to be attached to the information, the user taste information indicating the characteristics of the users by whom the advertisement provider wishes the advertisement to be viewed, and the user information of the user who purchase the information.

Furthermore, since a unit price is provided for the advertisement to be attached to the information in the present invention, it is possible to properly control the fee to be paid by the user for each piece of provided information and the advertisement fee to be paid by the advertiser.

Since an upper limit in the advertisement fee is provided, the advertiser can provide a quantity of advertising to the user which is commensurate with the advertisement fee he paid.

Since an association can be established between the advertisement provided by the advertiser and the user who views the advertisement, the advertiser can provide the advertisement to certain users.

All publications, patens and patent applications cited herein are incorporated herein by reference in their entirety.

### POTENTIAL FOR INDUSTRIAL APPLICATION

The present invention allows the advertiser to provide a quantity of advertising commensurate with the advertisement fee to certain users, while providing an advertisement-attached information providing apparatus which allows the user to enjoy discounts in the fee.

1. An advertisement-attached information providing apparatus for providing information attached with an advertisement, wherein the advertisement to be attached to the information is determined based on at least two pieces of information selected from the group consisting of advertisement desired information included in the information, user taste information included in the advertisement, and user information about a user who purchases the information.

2. The advertisement-attached information providing apparatus according to claim 1, wherein the advertisement carries an advertisement unit price which, corresponding to an advertisement fee, is incurred every time the advertisement is attached to the information, and the information is provided for a fee which is the price of the information minus the advertisement unit price.

3. The advertisement-attached information providing apparatus according to claim 1 or 2, wherein the advertisement further comprises data indicating an upper-limit price of the advertisement fee, and the attachment of the advertisement is halted when the total of the advertisement unit price, which is incurred every time the advertisement is attached to the information, exceeds the upper-limit price.

4. The advertisement-attached information providing apparatus according to any one of claims 1-3, wherein the advertisement further comprises data indicating an advertisement period, and the attachment of the advertisement is halted when the time or date of attaching the advertisement to the information has passed the advertisement period.

5. An advertisement-attached information providing method for providing information attached with an advertisement, the method comprising the steps of:
extracting advertisement desired information included in the information;
extracting user taste information included in the advertisement; and
determining an advertisement to be attached to the information based on the extracted advertisement desired information and the extracted user taste information.

6. The advertisement-attached information providing method according to claim 5, wherein in the case where user information about a user who purchases the information is provided, the content of an item of the advertisement desired information corresponding to each item of the provided user information is temporarily changed to the content of the user information.

7. A program for providing information attached with an advertisement, the program being designed to have a computer perform the steps of:
extracting advertisement desired information included in the information;
extracting user taste information included in the advertisement; and
determining an advertisement to be attached to the information based on the extracted advertisement desired information and the extracted user taste information.

8. A computer-readable recording medium recorded with a program for providing information attached with an advertisement, the program being designed to have a computer perform the steps of:
extracting advertisement desired information included in the information;
extracting user taste information included in the advertisement;
determining an advertisement to be attached to the information based on the extracted advertisement desired information and the extracted user taste information.

9. An advertisement-attached information providing method for providing information attached with an advertisement, comprising the steps of:
extracting an advertisement to be attached to information;
extracting an advertisement unit price corresponding to the extracted advertisement;
calculating a fee for the advertisement-attached information by subtracting the advertisement unit price from the price of the information; and
providing the advertisement-attached information.

10. A program for providing information attached with an advertisement, the program being designed to have a computer execute the steps of:
extracting an advertisement to be attached to information;
extracting an advertisement unit price corresponding to the extracted advertisement;
calculating a fee for the advertisement-attached information by subtracting the advertisement unit price from the price of the information; and
providing the advertisement-attached information.

11. A computer-readable recording medium recorded with a program for providing information attached with an advertisement, the program being designed to have a computer execute the steps of:
extracting an advertisement to be attached to information;
extracting an advertisement unit price corresponding to the extracted advertisement;
calculating a fee for the advertisement-attached information by subtracting the advertisement unit price from the price of the information; and
providing the advertisement-attached information.
